(19) United States
(12) Patent Application Publication
(10) Pub. No.: US 2018/0357398 A1
(43) Pub. Date: Dec. 13, 2018

(54) MOBILE TERMINAL AND CONTROL METHOD THEREOF

(71) Applicant: LG ELECTRONICS INC., Seoul (KR)

(72) Inventors: Kyunglang PARK, Seoul (KR); Jieun KIM, Seoul (KR); Hyukjae JANG, Seoul (KR)

(73) Assignee: LG ELECTRONICS INC., Seoul (KR)

(21) Appl. No.: 15/573,451

(22) PCT Filed: Sep. 10, 2015
(86) PCT No.: PCT/KR2015/009518

§ 371 Date: Nov. 10, 2017

(30) Foreign Application Priority Data
May 12, 2015 (KR) 10-2015-0066047

(51) Int. Cl. G06F 21/31; G06F 21/36; H04M 1/725; G06F 21/12

(52) U.S. Cl. CPC G06F 21/316; G06F 21/12; H04M 1/7258; G06F 21/36

(57) ABSTRACT

The present invention relates to a mobile terminal which can analyze a user's usage pattern and limit use of other users by using the analysis results; and a method for controlling the same. Specifically, the present invention relates to a mobile terminal comprising a control part which senses a user's usage pattern and sets a lock of a mobile terminal on the basis of the sensed usage pattern.

### TECHNICAL FIELD

The present invention relates to a mobile terminal and control method thereof, suitable for enabling a use of terminal to be implemented in further consideration of user's convenience.

### BACKGROUND ART

Terminals can be classified into mobile/portable terminals and stationary terminals. In particular, the mobile terminals can be further classified into handheld terminals and vehicle mounted terminals according to possibility of user's direct portability.

Recently, functions of a mobile terminal tend to be diversified. For instance, the diversified functions include a function of data and audio communication, a function of photographing and video-making through a camera, a function of audio recording, a function of music file play through a speaker system, a function of outputting an image or video to a display unit, and the like. A prescribed terminal is further equipped with an electronic game play function or performs a multimedia player function. Particularly, a recent mobile terminal is able to receive multicast signals for providing visual contents such as a broadcast, a video, a television program and the like.

As functions of the terminal are getting diversified, the terminal tends to be implemented as a multimedia player provided with complex functions such as photographing of photos or videos, playback of music or video files, game play, broadcast reception and the like for example.

To support and increase the terminal functions, it may be able to consider improving structural parts and/or software parts of the terminal.

As a most general method for another's use prevention, there is a method of setting a state of a mobile terminal to a locked sate. As a method of releasing such a locked state, a method of inputting a preset pattern or a password is available. However, each time a locked state is released, if a preset pattern or password is inputted, it may be considerably inconvenient. Therefore, the demand for a control method for another's use prevention as a more efficient method is rising.

### DISCLOSURE OF THE INVENTION

### Technical Task

One technical task of the present invention is to solve the above problem and other problems. Another technical task of the present invention is to provide a mobile terminal and control method thereof, by which another's use can be prevented in a manner of recognizing a user's use pattern.

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

In one technical aspect of the present invention, provided herein is a mobile terminal, including a memory storing a user's pre-used pattern, a sensing unit configured to sense a user's use pattern, and a controller setting a lock for the mobile terminal based on a result from comparing the sensed use pattern with the stored pre-used pattern.

In another technical aspect of the present invention, provided herein is a method of controlling a mobile terminal, including storing a user's pre-used pattern, sensing a user's use pattern, and setting a lock for the mobile terminal based on a result from comparing the sensed use pattern with the stored pre-used pattern.

### Advantageous Effects

Effects of a mobile terminal and control method thereof according to the present invention are described as follows.

According to at least one of embodiments of the present invention, inconvenience in user's use can be minimized while another's use is prevented.

Additional range of applicability of the present invention will become clear from the detailed description of the invention in the following. Yet, since it will be apparent to those skilled in the art that various modifications and variations can be made therein without departing from the spirit and scope of the invention, it is to be understood that the following detailed description of the present invention and a specific embodiment such as a preferred embodiment of the present invention are exemplary and explanatory.

### DESCRIPTION OF DRAWINGS

FIG. 1A is a block diagram to describe a mobile terminal related to the present invention.

FIG. 1B and FIG. 1C are conceptual diagrams of one example of a mobile terminal related to the present invention, viewed in different directions.

FIG. 2 is a diagram showing a control method of sensing a user's use pattern and setting a lock based on the sensed use pattern according to one embodiment of the present invention.

FIG. 3 is a diagram showing a control method of setting a lock for a mobile terminal itself based on a use pattern according to one embodiment of the present invention.

FIG. 4 is a diagram showing a flowchart of a control method of if a security point exceeds a preset value, setting a lock for an application according to one embodiment of the present invention.

FIG. 5 is a diagram showing a state in case of setting a lock for an application according to one embodiment of the present invention.

FIG. 6 is a diagram to describe an example of a control method of analyzing a use pattern for a swipe input.

FIG. 7 is a diagram to describe an example of a control method of analyzing a touch input pattern inputted to a user input unit 123 according to one embodiment of the present invention.

FIG. 8 is a diagram showing a left hand touch region 803-1 and a right hand touch region 803-2 divided according to one embodiment of the present invention.

FIG. 9 is a diagram to describe an inclining pattern of a mobile terminal 100 according to one embodiment of the present invention.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

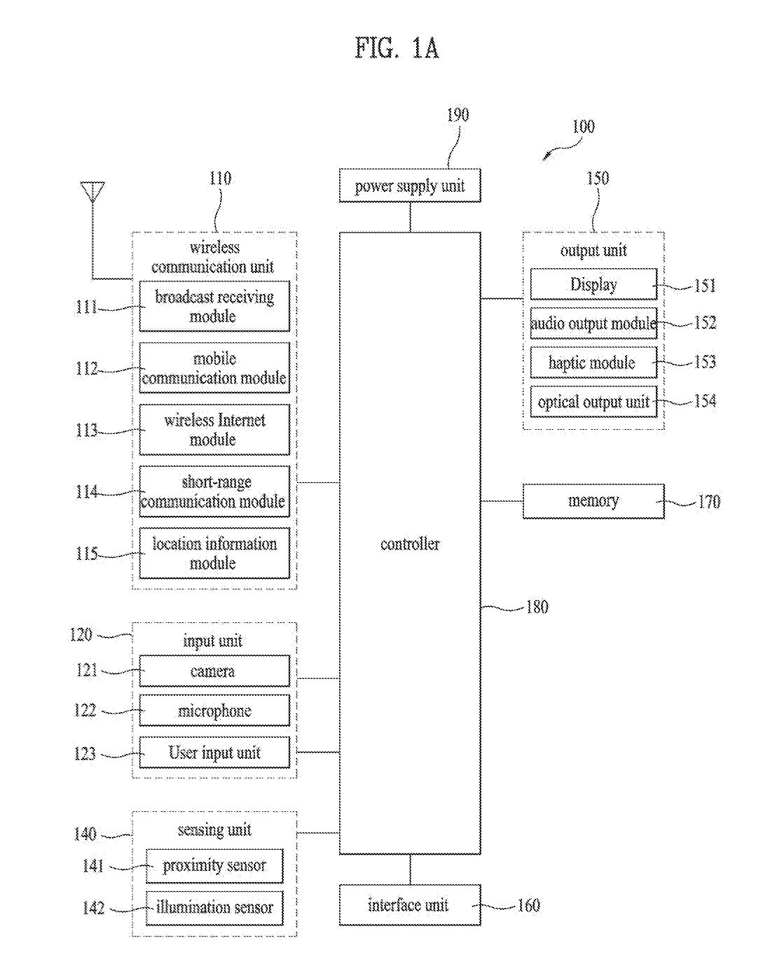

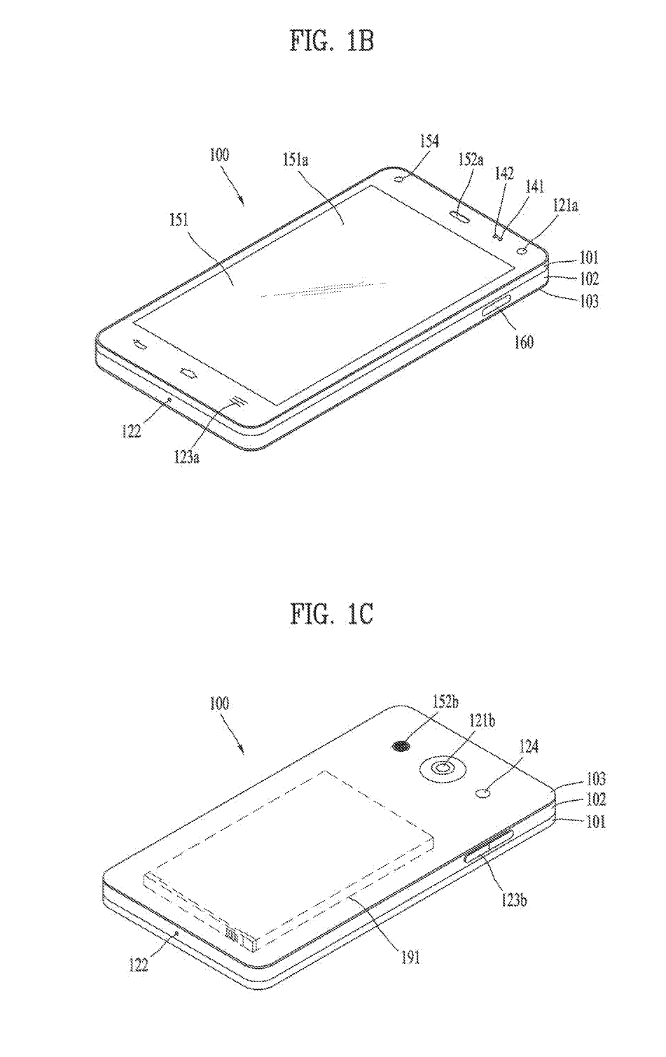

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented. Referring now to FIG. 1A, the mobile terminal 100 is shown having wireless communication unit 110 configured with several commonly implemented components.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a position location module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142. If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like inputted or outputted through the above-mentioned components and/or runs application programs saved in the memory 170, thereby processing or providing a user with appropriate information and/or functions.

The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1A according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The position-location module 115 is generally configured to detect, calculate, derive or otherwise identify a position of the mobile terminal. As an example, the position-location module 115 includes a Global Position System (GPS) module, a Wi-Fi module, or both. If desired, the position-location module 115 may alternatively or additionally function with any of the other modules of the wireless communication unit 110 to obtain data related to the position of the mobile terminal. As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 100. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images.

A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Also, various embodiments can be implemented in the computer and similar recording materials using software, hardware and the combination of software and hardware.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal.

In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the 1st audio output unit 152a, the 2nd audio output unit 152b, the proximity sensor 141, the illumination sensor 142, the light output unit 154, the 1st camera 121a, the 2nd camera 121b, the 1st manipulating unit 123a, the 2nd manipulating unit 123b, the microphone 122, the interface unit 160, and the like.

FIGS. 1B and 1C depict certain components as arranged on the mobile terminal.

However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices.

Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b may also be commonly referred to as a manipulating portion, and may employ any tactile method that allows the user to perform manipulation such as touch, push, scroll, or the like.

The first and second manipulation units 123a and 123b may also employ any non-tactile method that allows the user to perform manipulation such as proximity touch, hovering, or the like.

As another example of the user input unit 123, a rear input unit (not shown) may be located on the rear surface of the terminal body.

The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160.

Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

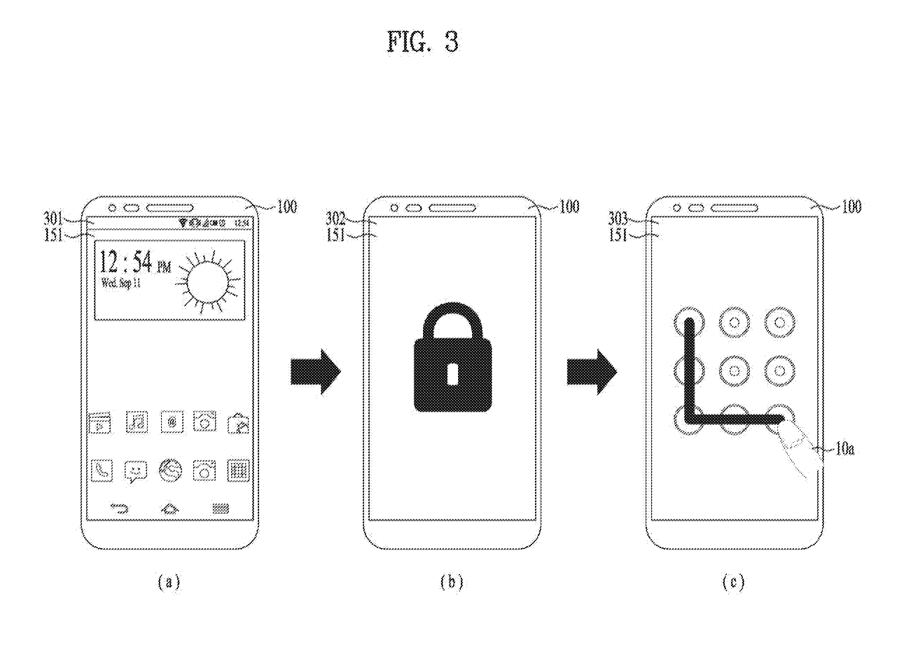

FIG. 3 is a perspective diagram showing a mobile terminal 300 of a watch type related to another embodiment of the present invention.

Referring to FIG. 3, a mobile terminal 300 of a watch type includes a main body 301 with a display unit 351 and a band 302 connected to the main body 301 to be wearable on a wrist. Generally, the mobile terminal 300 may include the features or similar features of the mobile terminal 100 shown in FIGS. 1A to 1C.

The main body 301 may include a case forming an exterior. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The mobile terminal 300 of the watch type is configured to enable wireless communication, and an antenna for the wireless communication can be installed in the main body 301. The antenna may extend its function using the case. For example, a case including a conductive material may be electrically connected to the antenna to extend a ground area or a radiation area.

The display unit 351 is disposed on the front side of the main body 301 so as to output information. The display unit 351 may include a touch sensor so as to implement a touchscreen. As illustrated, a window 351a of the display unit 351 is mounted on the first case 301a to form a front surface of the terminal body together with the first case 301a.

An audio output module 352, a camera 321, a microphone 322, a user input unit 323 and the like can be provided to the main body 301. When the display unit 351 is implemented as a touchscreen, it may function as the user input unit 323, whereby a separate key may not be provided to the main body 301.

The band 302 is commonly worn on the user's wrist and may be made of a flexible material for facilitating wearing of the device. As one example, the band 302 may be made of leather, rubber, silicon, synthetic resin, and/or the like. The band 302 may also be configured to be detachable from the main body 301. Accordingly, the band 302 may be replaceable with various types of bands according to a user's preference.

Meanwhile, the band 302 may be used in extending the performance of the antenna. For example, a ground extending unit (not shown) electrically connected to the antenna to extend a ground area may be embedded in the band 302.

The band 302 may be provided with a fastener 302a. The fastener 302a may be implemented into a buckle type, a snap-fit hook structure, a Velcro (trade mark) type, or the like, and include a flexible section or material. The drawing illustrates an example that the fastener 302a of a buckle type is implemented.

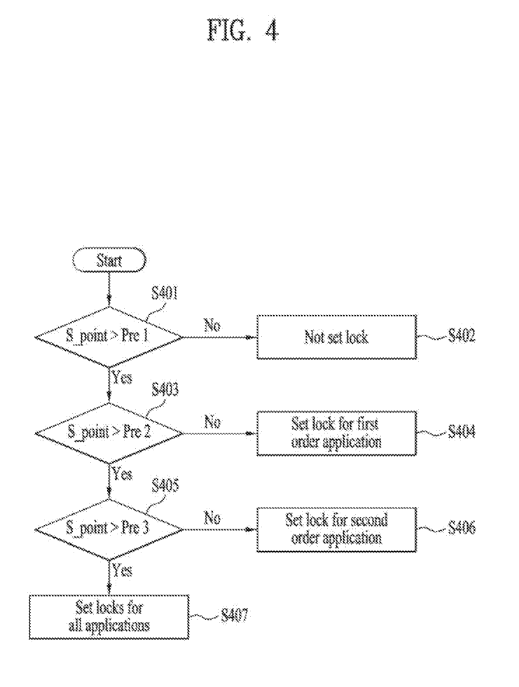

FIG. 4 is a perspective diagram showing one example of a mobile terminal 400 of a glass type related to another embodiment of the present invention.

The glass-type mobile terminal 400 is configured wearable on a head of a human body and provided with a frame part (e.g., case, housing, etc.) therefor. The frame part may be made of a flexible material to be easily worn. In the drawing, the frame part is shown having a first frame 401 and a second frame 402, which can be made of the same or different materials. In general, the mobile terminal 400 may be configured to include features that are the same or similar to those of the mobile terminal 100 of FIGS. 1A to 1C.

The frame may be supported on the head and defines a space for mounting various components. As illustrated, electronic components, such as a control module 480, an audio output module 452, and the like, may be mounted to the frame part. Also, a lens 403 for covering at least one of the left and right eyes may be detachably coupled to the frame part.

The control module 480 controls various electronic components disposed in the mobile terminal 400. The control module 480 may be understood as a component corresponding to the aforementioned controller 180. In the present drawing, the control module 480 is installed in the frame part on one side of the head, but other locations are possible.

The display unit 451 may be implemented as a head mounted display (HMD). The HMD refers to display techniques by which a display is mounted to a head to show an image directly in front of user's eyes. In order to provide an image directly in front of the user's eyes when the user wears the glass-type mobile terminal 400, the display unit 451 may be located to correspond to at least one of the left and right eyes. In the present drawing, the display unit 451 is illustrated as located on a portion corresponding to the right eye to output an image viewable by the user's right eye.

The display unit 451 may project an image into the user's eye using a prism. Also, the prism may be formed of optically transparent material such that the user can view both the projected image and a general visual field (a range that the user views through the eyes) in front of the user.

In such a manner, the image output through the display unit 451 may be viewed while overlapping with the general visual field. The mobile terminal 400 may provide an augmented reality (AR) by overlaying a virtual image on a real image or background using the features of the display.

The camera 421 may be disposed adjacent to at least one of the left and right eyes to capture an image. Since the camera 421 is located adjacent to the eye, the camera 421 can acquire a scene that the user is currently viewing.

In the present drawing, the camera 421 is illustrated as provided to the control module 480, and may be positioned at any location of the mobile terminal. The camera 421 may be installed in the frame part. Multiple cameras may be utilized to acquire a stereoscopic image.

The glass-type mobile terminal 400 may include user input units 423a and 423b, which can each be manipulated by the user to provide an input of a control command. The user input units 423a and 423b may employ techniques which permit input via a tactile input (tactile manner). Typical tactile inputs include a touch, push, or the like. In the present drawing, the user input units 423a and 423b are shown operable in a pushing manner and a touching manner as they are located on the frame part and the control module 480, respectively.

Moreover, the glass-type mobile terminal 400 may include a microphone (not shown) which processes input sound into electric audio data, and an audio output module 452 for outputting audio. The audio output module 452 may be configured to produce audio in a general audio output manner or an osteoconductive manner. When the audio output module 452 is implemented in the osteoconductive manner, the audio output module 452 may closely adhere to the head, when the user wears the mobile terminal 400, and vibrate the user's skull to transfer sounds.

Description will now be given according to various embodiment(s) for a control method implemented in the above-configured mobile terminal disclosed herein, with reference to the accompanying drawings. It will be appreciated by those skilled in the art that the present invention covers the modifications and variations of this invention provided they come within the scope of the appended claims and their equivalents.

As described in BACKGROUND ART of invention, as a general method for another's use prevention, there is a control method of setting a locked state for a mobile terminal. After a user has finished a use of a mobile terminal, if the user sets a locked sate for the mobile terminal, a security enabled state (i.e., a state unable to access an important function) is maintained until the locked state is released. Hence, when the user desires to use the mobile terminal again, the locked state should be released in the first place.

An input of a preset (touch) pattern, a method of inputting a preset password, a knock pattern, or the like may be taken as one example of a method of releasing a locked state. And, the locked state releasing method will be non-limited by the above examples. Such a preset pattern, a password or a knock code shall be named an unlock code.

Thus, each time a mobile terminal is used, if the unlock code is inputted, a use of the mobile terminal may be inconvenient considerably. Hence, according to one embodiment of the present invention, it is proposed to enter a locked state in a special situation only. Namely, after a use pattern of a mobile terminal has been recognized, only if another's use is recognized, a locked state can be entered. A detailed method of such an embodiment shall be described with reference to the accompanying drawing as follows.

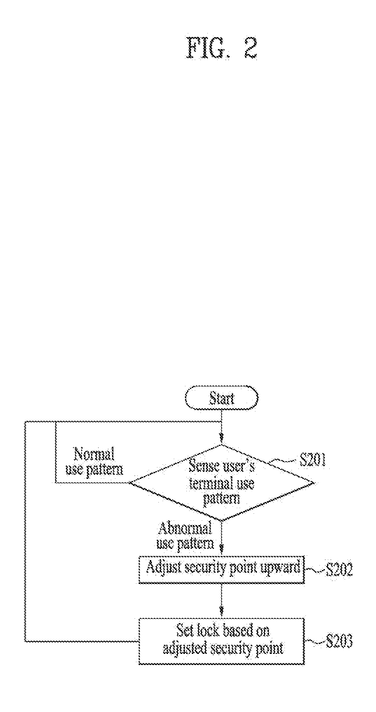

FIG. 2 is a diagram showing a control method of sensing a user's use pattern and setting a lock based on the sensed pattern according to one embodiment of the present invention.

Namely, according to one embodiment of the present invention, it is proposed to minimize a switching to a locked state and enter the locked state under a specific condition only.

In a step S201, the controller 180 senses a mobile terminal use pattern of a user. Namely, the controller 180 senses a mobile terminal use pattern of a user, thereby determining that a person who is not an original user (hereinafter named a user) of the mobile terminal is using the mobile terminal.

A user's pattern may include a pressure of a user's touch to the touchscreen 151, an inter-text input rhythm on typing specific texts, a typing pattern, a distance and pattern of a swipe touch input or the like. Moreover, an angle at which a user holds the mobile terminal may be considered.

If the user's terminal use pattern sensed in the step S201 is determined as a normal use pattern, the step S201 can be performed repeatedly.

On the other hand, if the user's terminal use pattern sensed in the step S201 is determined as an abnormal use pattern, the routine may go to a step S202.

According to one embodiment of the present invention, an abnormal extent is converted into a point. If the point is equal to or greater than a prescribed numerical value, it is proposed to determine that it is not a use by other person. A person may input a pattern slightly different from a generally used pattern unless being a machine. Particularly, a use pattern may be differentiated in an abnormal situation such as a drunken state, a car-driving state, and the like. Hence, when there exists an abnormal use partially, if a lock is directly set, it may cause inconvenience as well. Thus, such an abnormal use pattern is converted into a point to be managed. If the abnormal use pattern is repeated, a lock is set. To perform such a function, it is necessary to convert an abnormal extent into a numerical value.

As described above, according to one embodiment of the present invention, it an abnormal extent is converted into a numerical value, such a value shall be named a security point, by which the present invention is non-limited.

In the step S202, if the use pattern sensed in the step S201 is abnormal, the security point can be adjusted upward.

In a step S203, the controller 180 may control a lock to be set based on the adjusted security point.

The lock setting may be performed per application. And, a lock of the mobile terminal itself may be set. One example of a lock setting is described with reference to FIG. 3 and FIG. 4 as follows.

FIG. 3 is a diagram showing a control method of setting a lock for a mobile terminal itself based on a use pattern according to one embodiment of the present invention.

Referring to FIG. 3 (a), the mobile terminal 100 is outputting a home screen 301 through the touchscreen 151.

The home screen 301 is described in detail as follows.

First of all, the home screen 301 may be generally defined as a screen displayed on the touchscreen 151 when a locked state of the touchscreen 151 is released. And, at one or more icons or widgets may be displayed on the home screen 301 to launch an application or an internal function. Two or more home screens 301 may exist on the mobile terminal 100 as well as one home screen 301. In this case, if a prescribed touch gesture is performed on the touchscreen 151, the two or more home screens 301 may be sequentially displayed one by one. Different icons (or widgets) may be disposed on the home screens 301, respectively.

While the home screen 301 is outputted, if an abnormal use pattern is sensed, the controller 180 may apply a lock setting (cf. FIG. 3 (b)) to the mobile terminal 100 itself [S202 and S203 in FIG. 2]. For example, if the adjusted security point exceeds a preset value, the controller 180 may set a lock for the mobile terminal 100 itself. Once the lock is set, a user is unable to access at least one function of the mobile terminal 100. To release such a lock, as shown in FIG. 3 (c), an input 10a of an unlock code may be applied.

Furthermore, according to one embodiment of the present invention, if the number of incorrect inputs of the unlock code exceeds a prescribed count, the controller 180 may send a text notification to a prescribed counterpart terminal. In this case, the prescribed counterpart terminal may include a terminal previously set by a user or a terminal having a high frequency of contacts with a user.

Meanwhile, despite that the unlock code is already inputted by the above method, the use pattern may be still abnormal. In this case, according to one embodiment of the present invention, a re-input of the password is demanded or an additional authentication method may be further demanded. As an example of the additional authentication method, a voice authentication, a face recognition, an additional personal information input or the like may be taken. If additional authentication is not completed, it may be able to control a lock to be set for the mobile terminal 100 itself.

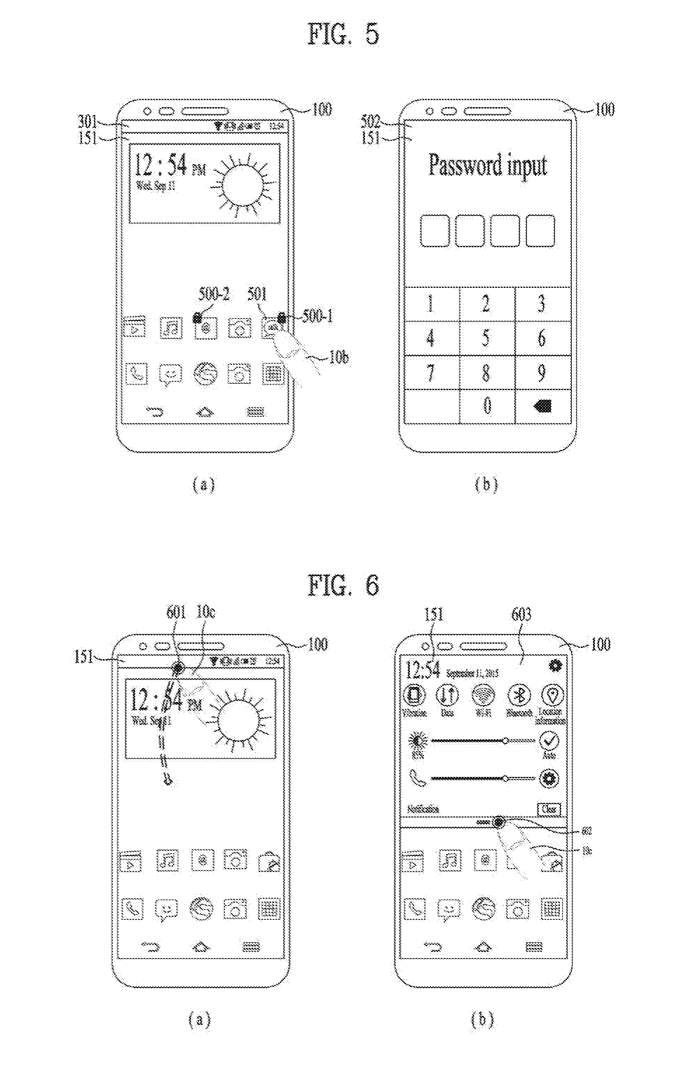

According to another embodiment of the present invention, if a security point exceeds a preset value, when a specific application or every application is entered, a preset pattern or a password may be demanded. Such an embodiment is described with reference to a flowchart of FIG. 4 and a state diagram of FIG. 5.

FIG. 4 is a diagram showing a flowchart of a control method of if a security point exceeds a preset value, setting a lock for an application according to one embodiment of the present invention. FIG. 5 is a diagram showing a state in case of setting a lock for an application according to one embodiment of the present invention. The following description is given with reference to FIG. 4 and FIG. 5 both.

According to one embodiment of the present invention, as a value of a security point is adjusted, it is proposed to set a lock for an application individually or collectively. Moreover, according to another embodiment of the present invention, as a security point is adjusted, it is proposed to set a lock step by step.

The whole flowchart shown in FIG. 4 may correspond to the step S203 in FIG. 2. In the whole flowchart, S_point indicates the security point and Pre 1 to Pre 3 may mean first to third preset values, respectively.

In a step S401, the controller 180 determines whether a security point exceeds a first preset value. If the security point does not exceed the first preset value, a lock may not be set for any application [S402]. Namely, as a use by a rightful user is determined, no restriction is put on a use of an application.

In a step S403, the controller 180 determines whether the security point exceeds a second preset value. Namely, if the security point lies between the first and second preset values, the routine may go to a step S404. In the step S404, a lock may be set for a first order application. There may be an application that demands a high security per function. For example, there is an application related to banking. Such an application may cause a financial damage unless the parties to a use. Hence, by giving a security priority, a lock is firstly set for an application corresponding to a first priority.

Subsequently, in a step S405, the controller 180 determines whether the security point exceeds a third preset value. Namely, if the security point lies between the second and third preset values, the routine may go to a step S406. In the step S406, locks may be set for the first priority application and a second priority application. Namely, the application corresponding to a second order is locked together with the application corresponding to the first order. Examples of such applications may include a personal message transceiving application, a diary application, a gallery application and the like. Such applications may have a security level lower than that of a banking related application. Yet, since such applications may have possible violation of privacy, they may have priorities higher than those of other applications.

Finally, if the third preset value is exceeded in the step S405, the controller 180 goes to a step S407 so as to set locks for all applications.

A state diagram in case of locking an application is described with reference to FIG. 5 as follows.

Referring to FIG. 5 (a), the aforementioned home screen 301 is being outputted. And, an icon 501 for a prescribed application is outputted. If an input 10b of selecting the icon 501 is received, the controller 180 launches a corresponding application and may output a corresponding running screen to the touchscreen 151.

According to one embodiment of the present invention, if the icon 501 is touched for a locked application, as shown in FIG. 5 (b), the controller 180 outputs a password demanding screen 502. Only if a preset password is inputted through the password demanding screen 502, the controller 180 may output an application running screen.

In doing so, the controller 180 may output indicators 500-1 and 500-2, each of which indicates that a lock is set, to icons of locked applications, respectively.

Furthermore, according to another embodiment of the present invention, if a correct password is not inputted in response to the demand for the password input, the mobile terminal 100 may be controlled to be locked. For example, if an incorrect password is inputted multiple times over a preset count, a lock setting of an application is changed into a lock setting of the mobile terminal 100 itself.

In the aforementioned step S201, in order to distinguish a rightful user or a use of other person, a user's terminal use pattern is sensed. A method of sensing a terminal use pattern is described in detail as follows.

According to one embodiment of the present invention, in analyzing a use pattern of a terminal, it is able to analyze: (1) a user's touch input pattern; (2) a menu use pattern; (3) a keypad input pattern; and (4) a terminal inclining pattern.

User's Touch Input Pattern Analysis

Each person has a different thumb length, a different palm length, a different muscle structure and the like. Hence, when such a person applies a touch input to the mobile terminal 100, each input pattern has no choice but to be different. In simple language, a long-fingered person and a short-fingered person differ from each other in a touchable radius, a drag distance and the like.

Therefore, according to one embodiment of the present invention, it is proposed to analyze a user's terminal use pattern based on a pattern of a touch input.

Examples of a touch input may include a time taken for tap down/up, a time taken for an input of double/triple taps, a location/sped/length/direction of a swipe input, a moving distance and a taken time pattern of a zoom-in/out input, a touch area, etc.

If a user applies a touch to the touchscreen 151, the touch input may include various informations as well as a simple location information. That is, since a user's finger touches the touchscreen 151, informations such as an area of a touched part, a pressure of the touch, a drag moving speed and the like may be included.

With reference to FIG. 6, an example of a control method of analyzing a use pattern for a swipe input is described.

Referring to FIG. 6 (a), a home screen is outputted through the touchscreen 15 of the mobile terminal 100. If receiving an input 10c (e.g., swipe input) of touching a prescribed top point 601 of the home screen and moving to another point 602 by dragging the touch in a bottom direction, as shown in FIG. 6 (b), the controller 180 may output a prescribed control window 603 to the touchscreen 151.

Namely, in order to control system settings on the home screen easily, the prescribed control window 603 can be provided.

In outputting the control window 603, it is necessary to firstly touch a prescribed top point of the home screen. So, every person may have a different touched location of the prescribed point. For example, when a person holds the mobile terminal 100 in one hand and controls the touchscreen 151 with the other hand, the person may apply a swipe input by touching a top center point of the home screen. Yet, when applying a swipe input with a thumb of the hand in which the mobile terminal 100 is held, the person may touch a point inclining toward a thumb located position. Moreover, each person may have a different drag distance or a different moving path.

In brief, the controller 180 can analyze patterns of a start point, an end point, a dragged speed, a dragged inclination and the like of a swipe input applied to the touchscreen 151. This is because as described above, each person may have a different pattern of a swipe input depending on a finger length, a muscle structure, a habit and the like.

Moreover, the controller 180 may consider an area of a touch input, a relative distance between a plurality of touch points in case of a multi-touch, a moving speed and the like together.

Menu Use Pattern

According to one embodiment of the present invention, it is proposed to analyze a user's input applied through the user input unit 123 provided to the mobile terminal 100.

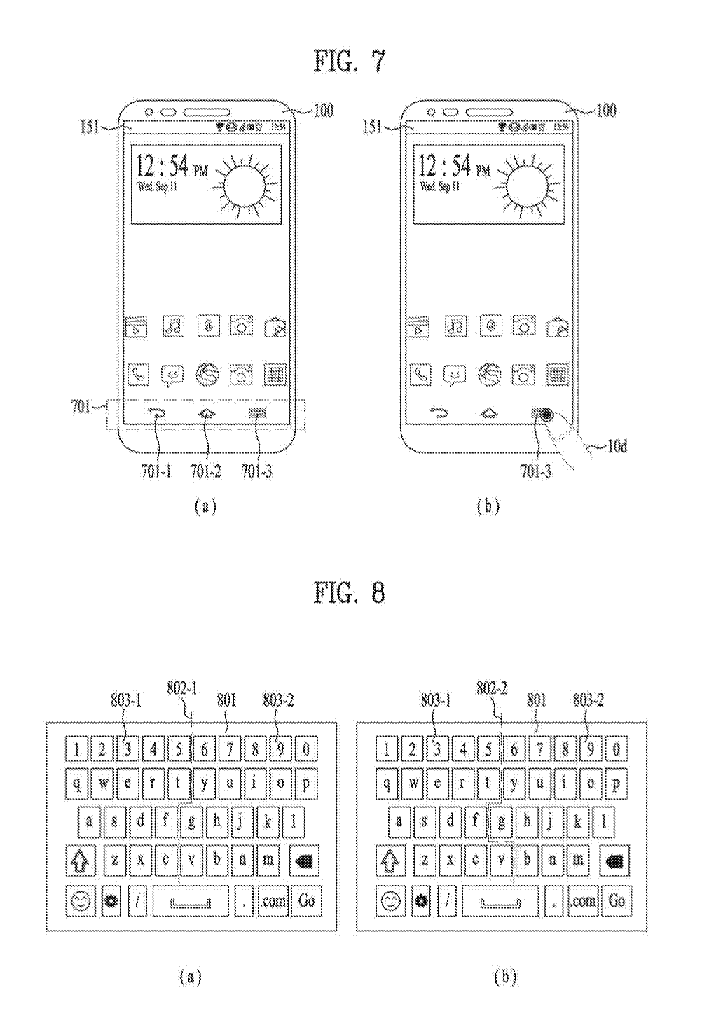

FIG. 7 is a diagram to describe an example of a control method of analyzing a touch input pattern inputted to the user input unit 123 according to one embodiment of the present invention.

Referring to FIG. 7, the touchscreen 151 is outputting a home screen. The controller 180 is outputting a button region 701 to a bottom edge of the touchscreen 151 and buttons 701-1 to 701-3 are outputted to the button region.

Examples of the buttons outputted to the button region 701 shown in FIG. 7 are described as follows. The button 701-1 is a backward (return) button that is a button for returning to a first screen from a second screen when the first screen is switched to the second screen within an application running screen. Namely, if receiving a command for selecting the button 70101 on the second screen, the controller 180 returns to the first screen and is able to output the returning first screen. The button 701-2 is a home button that is a button for outputting a home screen in the course of outputting a running screen of an application (or, other screen).

The button 701-3 is a button for calling a menu list. In this case, the called menu list may include an appropriate menu list outputted to a screen outputted at the timing of inputting a menu list call. For example, while a home screen is outputted, if the button 701-3 is inputted, the controller 180 may call a menu list for setting the home screen. Yet, if the button 701-3 is inputted in the course of outputting a prescribed application, the controller 180 may call a setting menu list of the corresponding application.

Meanwhile, the button region 701 and the buttons outputted to the button region 701 are just examples. And, it is obvious that a different button region and/or buttons of different types can be displayed.

The button region 701 is described by taking the buttons currently outputted to the touchscreen 151 as examples. Moreover, the same principle may be applied to the hardware key provided to the case forming the exterior of the mobile terminal 100. Namely, according to one embodiment of the present invention, ‘backward button 701-1’, ‘home screen button 701-2’ and/or ‘menu call button 701-3’ is applicable to a hardware key as well as a software key.

Every person may habitually select the buttons. For example, one person may apply buttons by pressing them once only. Yet, another person may press buttons consecutively. Thus, if a pattern of selecting a button is sensed, a use of a rightful user may be distinguished from a use of other person. As the patterns, a count of consecutively pressing a button, a period of pressing a button and the like may be considered.

A method of distinguishing a user using a keypad use pattern is described with reference to FIG. 8 as follows.

Keypad Input Pattern

Each user has a different typing manner. This is because each user may have a different typing speed, a different area of touching a button of a keypad, a different habitual mistyping occurrence and the like.

First of all, according to one embodiment of the present invention, a use pattern may be determined based on a typing speed. Depending on a typing skip, a finger length or the like, one person may have a fast typing speed or another person may have a slow typing speed. Particularly, it may be able to measure a speed for a word/sentence becoming a specific reference. For example, assuming that an average time taken for a rightful user to complete a sentence ‘Annyunghaseyo’ is 5 seconds, if a typing speed exceeding 10 seconds is sensed, a use by other person is determined.

Additionally, according to another embodiment of the present invention, a use pattern may be determined with reference to a typing error for a specific word. For example, when a rightful user frequently makes a typing error ‘habinda’ in typing a word ‘hamnida’, if an input of the same typing error for the same word is received, the controller 180 may determine it as a use of a rightful user. If a typing error for the same word is not made, the aforementioned security point may be adjusted upward.

Additionally, according to another embodiment of the present invention, a use pattern may be determined depending on whether a specific special text pattern is inputted. For example, when there is a user who puts a period at the end of a sentence, if an input of failing to put a period at the end is received, it may be determined as a use by other person. Furthermore, when there is a user who frequently uses a special text combination like ‘˜!’ at the end of a sentence, if ‘˜!’ is inputted, it is determined as a use of a rightful user by analyzing such a pattern. Hence, a security point may be controlled to be adjusted downward.

Moreover, according to another embodiment of the present invention, after a typing region for a left hand and a typing region for a right hand have been distinguished from each other, it is proposed to determine whether such distinguishment is the same as a rightful user distinguishing method. Such an embodiment is described with reference to FIG. 8.

In case of analyzing a touch area, assume a state capable of determining whether a touch input is performed by a left hand or a right hand. Namely, in case of analyzing a touch area recognized on touching the touchscreen 151 with a finger, it may be able to distinguish whether it is a touch with a left hand or a touch with a right hand. Or, when an input is applied with both hands, an inclining degree at the timing of typing with right and left hands is sensed. Subsequently, using the sensed result, it is able to determine the left hand or the right hand. Furthermore, without being limited by these methods, various methods of determining whether a touch to the touchscreen 151 is applied with a left hand or a right hand are applicable to one embodiment of the present invention.

FIG. 8 is a diagram showing a left hand touch region 803-1 and a right hand touch region 803-2 divided according to one embodiment of the present invention.

FIG. 8 (a) shows a touch region distinguished by a first user, and FIG. 8 (b) shows a touch region distinguished by a second user. Referring to FIG. 8 (a), the first user does not distinguish other key buttons but uses a right hand in touching a button V. Namely, the button ‘v’ is located in the right hand region 803-1 that is a right side of a first boundary 802-1.

On the other hand, referring to FIG. 8 (b), if a region distinguished by the second user is referred to, the button ‘v’ is located in the left hand region 803-1 that is a left region of a second boundary 802-2.

Thus, left and right hand regions may vary per user, the controller 180 may use such a region distinguishment as a use pattern.

Terminal Inclining Pattern

According to one embodiment of the present invention, whether it is a user' determination is determined using a pattern of inclining a terminal and a security point may be then adjusted upward or downward based on the determination. Namely, if an inclination of the mobile terminal deviates from a prescribed angle range, the controller 180 may set a lock of the mobile terminal. Here, the prescribed angle range may include an angle range learned by the mobile terminal 100.

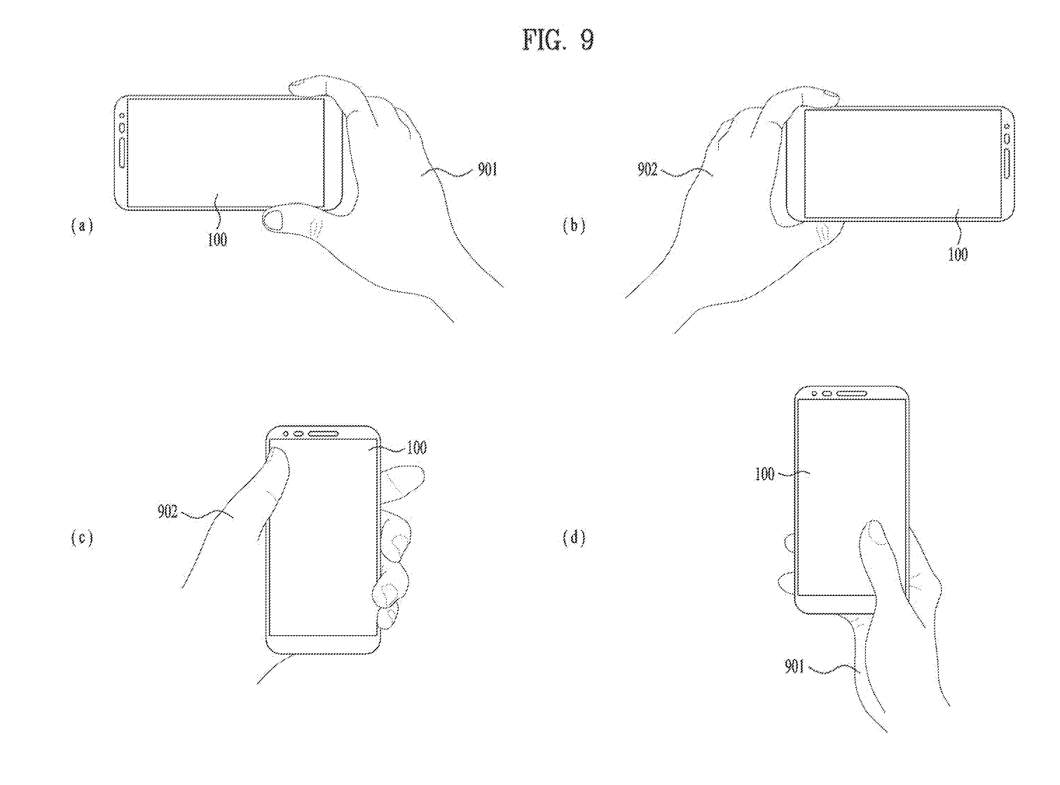

Such an embodiment is described with reference to FIG. 9.

FIG. 9 is a diagram to describe an inclining pattern of a mobile terminal 100 according to one embodiment of the present invention.

FIG. 9 (a) shows that the mobile terminal 100 inclining in a width direction is held in a right hand 901. FIG. 9 (b) shows that the mobile terminal 100 inclining in the width direction is held in a left hand 902.

FIG. 9 (c) shows that the mobile terminal 100 inclining in a length direction is held in the left hand 902. FIG. 9 (d) shows that the mobile terminal 100 inclining in the length direction is held in the right hand 901.

The mobile terminal 100 may be able to distinguish the 4 kinds of the holding methods. There may be a pattern of an angle for a user to incline the mobile terminal 100 to correspond to each of the distinguished holding methods. According to one embodiment of the present invention, after the inclining pattern has been learned, if an inclination deviating from the learned pattern is sensed, a security point can be controlled to be adjusted upward.

For example, while the mobile terminal inclining in the length direction is held in the left hand 902, as shown in FIG. 9 (c), assume that a rightful user uses a pattern of inclining in an angle range between 50 to 60 degrees. If the use is maintained in a state of an inclination at 40 degrees, the controller 180 may control a security point to be adjusted upward.

Or, it may be able to sense an inclining pattern in a specific application running state. When a camera shot application, a phone application, a video watch application, or a specific game application is launched, it may be able to determine whether it is a use of a rightful user or a sue of other person using an inclining degree. Namely, while a prescribed application is running, if an inclination of the mobile terminal deviates from a prescribed angle range, the controller 180 may set a lock for the mobile terminal.

The present invention mentioned in the foregoing description can be implemented in a program recorded medium as computer-readable codes. The computer-readable media may include all kinds of recording devices in which data readable by a computer system are stored. The computer-readable media may include HDD (Hard Disk Drive), SSD (Solid State Disk), SDD (Silicon Disk Drive), ROM, RAM, CD-ROM, magnetic tapes, floppy discs, optical data storage devices, and the like for example and also include carrier-wave type implementations (e.g., transmission via Internet). Further, the computer may include the controller 180 of the terminal. The foregoing embodiments are merely exemplary and are not to be considered as limiting the present disclosure. The present teachings can be readily applied to other types of methods and apparatuses. Thus, it is intended that the present invention covers the modifications and variations of this invention that come within the scope of the appended claims and their equivalents.

### Mode for Invention

Various embodiments are described in ‘BEST MODE FOR INVENTION’ for implementing the present invention.

### INDUSTRIAL APPLICABILITY

The present invention is used for a series of mobile terminal related fields.

It will be appreciated by those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A mobile terminal, comprising:
a memory configured to store a user's pre-used pattern;
a sensing unit configured to sense a user's use pattern; and
a controller configured to set a lock for the mobile terminal based on a result from comparing the sensed use pattern with the stored pre-used pattern.

2. The mobile terminal of claim 1, wherein if the sensed user's use pattern is abnormal, the controller is further configured to adjust a security point upward and sets the lock of the mobile terminal based on the adjusted security point.

3. The mobile terminal of claim 2, wherein if the security point exceeds a first value, the controller is further configured to set a lock for a first application.

4. The mobile terminal of claim 3, wherein if the security point exceeds a second value, the controller is further configured to set locks for the first application and a second application.

5. The mobile terminal of claim 1, wherein the user's use pattern comprises a use pattern for a touch input applied to a touchscreen.

6. The mobile terminal of claim 5, wherein the user's use pattern comprise at least one selected from the group consisting of a point of receiving a touch input, a dragged speed in a touch maintained state, a dragged distance in the touch maintained state, and a shifted point by being dragged in the touch maintained state.

7. The mobile terminal of claim 1, further comprising a user input unit including a prescribed function button, wherein the user's use pattern comprises a consecutively pressed count or period in case of selecting the prescribed function button.

8. The mobile terminal of claim 1, further comprising a sensing unit sensing an inclination of the mobile terminal, wherein the user's use pattern comprises a pattern for the inclination of the mobile terminal.

9. The mobile terminal of claim 8, wherein if the inclination of the mobile terminal deviates from a prescribed angle range, the controller is further configured to set the lock for the mobile terminal.

10. The mobile terminal of claim 8, wherein if the inclination of the mobile terminal deviates from a prescribed angle range in a prescribed application running state, the controller is further configured to set the lock for the mobile terminal.

11. A method of controlling a mobile terminal, comprising:
storing a user's pre-used pattern;
sensing a user's use pattern; and
setting a lock for the mobile terminal based on a result from comparing the sensed use pattern with the stored pre-used pattern.

12. The method of claim 11, further comprising if the sensed user's use pattern is abnormal, adjusting a security point upward and sets the lock of the mobile terminal based on the adjusted security point.

13. The method of claim 12, the setting the lock, comprising if the security point exceeds a first value, setting a lock for a first application.

14. The method of claim 13, the setting the lock, comprising if the security point exceeds a second value, setting locks for the first application and a second application.

15. The method of claim 11, wherein the user's use pattern comprises a use pattern for a touch input applied to a touchscreen.

16. The method of claim 15, wherein the user's use pattern comprise at least one selected from the group consisting of a point of receiving a touch input, a dragged speed in a touch maintained state, a dragged distance in the touch maintained state, and a shifted point by being dragged in the touch maintained state.

17. The method of claim 11, wherein the user's use pattern comprises a consecutively pressed count or period in case of selecting a prescribed function button included in a user input unit.

18. The method of claim 11, further comprising sensing an inclination of the mobile terminal, wherein the user's use pattern comprises a pattern for the inclination of the mobile terminal.

19. The method of claim 18, the setting the lock, comprising if the inclination of the mobile terminal deviates from a prescribed angle range, setting the lock for the mobile terminal.

20. The method of claim 18, the setting the lock, comprising if the inclination of the mobile terminal deviates from a prescribed angle range in a prescribed application running state, setting the lock for the mobile terminal.
